(19) United States
(12) Patent Application Publication
(10) Pub. No.: US 2026/0016840 A1
(43) Pub. Date: Jan. 15, 2026

(54) AUTOMATED FLIGHT PATH GENERATION FOR INSPECTION DRONE

(71) Applicant: SKYYFISH LLC, Stevensville, MT (US)

(72) Inventors: Gary L. VIVIANI, Bastrop, TX (US); Christopher Nicholas BURGOYNE, Saint Ignatius, MT (US)

(21) Appl. No.: 19/054,862

(22) Filed: Feb. 16, 2025

(30) Foreign Application Priority Data
Jul. 11, 2024 (CA) 3247340

(51) Int. Cl. G05D 1/689; B64U 10/13; B64U 101/26; B64U 101/30; G05D 1/229; G05D 105/80

(52) U.S. Cl. CPC G05D 1/689; B64U 10/13; G05D 1/229; B64U 2101/26; B64U 2101/30; G05D 2105/89

(57) ABSTRACT

Inspection of structures such as cell towers can be difficult and time-consuming. By automating the generation of a flight path for an autonomous inspection drone, the inspection process is improved. To determine the flight path, the structure is preliminarily photographed from two adjacent sides. The lateral extent of the structure is determined for both views. Enveloping ellipses centered on the axis of the structure and spanning its height are calculated. These are enlarged, for incorporation into the flight path, which also includes ellipses or circles forming a dome above the structure. Waypoints are defined on the flight path, at which inspection photographs are taken for analysis. The drone may pass more than once along part or all of the flight path, and the tilt of the camera may be different in each pass.

### CROSS-REFERENCE TO RELATED APPLICATIONS

The present application claims the benefit of Canadian Application Ser. No. 3,247,340, filed on Jul. 11, 2024, which is herein incorporated by reference for completeness of disclosure.

### BACKGROUND OF THE INVENTION

Unmanned Aerial Vehicles (UAVs), also known as drones, have become commonplace in our society these days. While millions of consumers worldwide own and use drones for fun and taking pictures of various targets, commercial drone applications are still evolving.

Applications for commercial drones include surveillance and inspection. This includes, for example, the inspection of cell towers for mobile telecommunications. Tall structures, such as cell towers, pose a challenging path-planning problem for drone-based photogrammetry. The main issue is one of determining how to circumnavigate an irregularly shaped tower to collect a sequence of photographs for rendering a detailed three-dimensional (3D) image of the structure. Such mensuration operations are important, as manually climbing a tower to perform an inspection is time consuming and a safety risk, and provides limited information compared with a photogrammetric 3D image. Such renderings also have the useful benefit that they can be compared and contrasted to previous ones, to discern changes such as deterioration of and damage to antennae and other critical components.

To date, methods that do not require extensive drone-pilot interaction do not exist. One existing approach requires the pilot to manually fly a drone into the area of the extremities of the object of interest. By the pilot standing at a distance from the tower, the pilot then “marks” the spot that he thinks is the appropriate position and then repeats the process at multiple measurement points. This is inherently somewhat inaccurate and is not easy to automate without extensive and complex machine vision.

This background is not intended, nor should be construed, to constitute prior art against the present invention.

### SUMMARY OF THE INVENTION

The main contribution of this invention is making the structure inspection process more automated and efficient. This is accomplished in part with specialized algorithms that have not been previously known to the state of the art. The process begins by determining a structure to be inspected. This step can be manual or automated. For example, machine learning (ML) is used to train a drone to recognize a structure of interest. The drone then orients itself to utilize its onboard camera to create an image of the structure. The drone then autonomously determines a suitable flight path to gather a sequence of photographs that are suitable for supporting a photogrammetric 3D representation of the structure. Traditionally, preparing to make photogrammetric measurements requires pilot-intensive flight maneuvers. This is extremely manual in nature. Even if these manual flight maneuvers were fully automated, the associated measurements that are derived from utilizing aircraft position would not be as precise as deriving physical dimensions from the pixel-based information of a photograph. Instead, this new method requires only two still photographs, from known locations of the drone, in order to derive all the pertinent tower related measurements. By comparison, existing manual approaches require the pilot to fly the drone to particular corner points of the tower in question in order to determine the size and shape of the tower to be inspected. This is subject to various forms of inaccuracy, including human error. This also is a time consuming process. Alternatively, the pertinent measurements for the structure to be inspected can be completely determined from two static photographs, virtually instantaneously (based on CPU calculations), and at much greater accuracy, which is only limited by the resolution of the photographic lens and image detector employed. This is valid for any three-dimensional object such as a cell tower or other object of interest. The determination of the geometry of the flight path requires minimal GPS (Global Positioning System) data.

In an object of this invention, to determine the flight path, the structure is photographed from two or more adjacent sides. From this, the lateral extent of each horizontal slice of the structure is determined, for two or more views. Next, enveloping ellipses that are centered on the axis of the structure are calculated around each slice. The enveloping ellipses only just enclose the portion of the structure within the corresponding slice. Enlarged ellipses are then calculated from the enveloping ellipses. Some or all of the enlarged ellipses are selected as flight ellipses, which are then connected together to form the flight path. Waypoints are defined on the flight ellipses, at which further photographs of the structure are taken for photogrammetric representation of the structure. The drone may pass more than once along any segment of the path, and the direction of the camera may be different in each pass, in order to accommodate different angles of the portions of the structure.

Disclosed is a method for inspecting a tower with an axis, the method comprising: taking two preliminary photographs of the tower, each from a different side of the tower, with an angle between the preliminary photographs of 90° [symbol] 45°; detecting, by one or more processors, outermost lateral edges of the tower in each preliminary photograph; from the outermost lateral edges calculating, by the one or more processors, an enveloping ellipse at each of multiple different heights of the tower, each enveloping ellipse centered on the axis and dimensioned to just enclose the tower at the corresponding height; calculating, by the one or more processors, an enlarged ellipse for each of the enveloping ellipses; generating, by the one or more processors, a flight path that incorporates at least some of the enlarged ellipses; and taking, using a drone carrying a camera, inspection photographs of the tower while flying the drone on the flight path.

Also disclosed is a drone for inspecting a tower, the drone comprising a camera, one or more processors and computer readable memory storing computer readable instructions which, when executed by the one or more processors cause the drone to: take two preliminary photographs of the tower, each from a different side of the tower, with an angle between the preliminary photographs of 90° 045°; detect outermost lateral edges of the tower in each preliminary photograph; from the outermost lateral edges, calculate an enveloping ellipse at each of multiple different heights of the tower, each enveloping ellipse centered on an axis of the tower and dimensioned to just enclose the tower at the corresponding height; calculate an enlarged ellipse for each of the enveloping ellipses; generate a flight path that incorporates at least some of the enlarged ellipses; and take inspection photographs of the tower while flying on the flight path.

This summary provides a simplified, non-exhaustive introduction to some aspects of the invention, without delineating the scope of the invention.

### BRIEF DESCRIPTION OF DRAWINGS

The above and other aspects, features and advantages of the invention will be more apparent from the following more particular description thereof, presented in conjunction with the following drawings wherein:

FIG. 1 is a schematic representation of a preliminary photograph that is one of a pair of isometric views of a cell tower, according to an embodiment of the present invention.

FIG. 2 is a schematic representation of a secondary preliminary photograph of the same cell tower taken at a right angle to the photograph of FIG. 1, according to an embodiment of the present invention.

FIG. 3 is a top view of the cell tower.

FIG. 4 is an outline of the lateral extent of the cell tower as depicted in FIG. 1, according to an embodiment of the present invention.

FIG. 5 is an outline of the lateral extent of the cell tower as depicted in FIG. 2, according to an embodiment of the present invention.

FIG. 6 is a sectional view of the cell tower at level A and a corresponding flight path at that level, according to an embodiment of the present invention.

FIG. 7 is a sectional view of the cell tower at level B and a corresponding flight path at that level, according to an embodiment of the present invention.

FIG. 8 is a sectional view of the cell tower at level C and a corresponding flight path at that level, according to an embodiment of the present invention.

FIG. 9 is a portion of a flight path with waypoints, according to an embodiment of the present invention.

FIG. 10 is the top portion of a flight path that would have a downward looking camera angle in order to capture information seen from the top, according to an embodiment of the present invention.

FIG. 11 is a slanted view of a flight path including upper dome and waypoints, according to an embodiment of the present invention.

FIG. 12 is a side view of the flight path in FIG. 11.

FIG. 13 is a system for automated cell tower inspection, according to an embodiment of the present invention.

FIG. 14 is a flowchart for automated cell tower inspection, according to an embodiment of the present invention.

### DETAILED DESCRIPTION OF THE INVENTION

The present invention comprising______—will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to”, “at least”, “greater than”, “less than”, and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth. The phrases “and ranges in between” can include ranges that fall in between the numerical value listed. For example, “1, 2, 3, 10, and ranges in between” can include 1-1, 1-3, 2-10, etc. Similarly, “1, 5, 10, 25, 50, 70, 95, or ranges including and or spanning the aforementioned values” can include 1, 5, 10, 1-5, 1-10, 10-25, 10-95, 1-70, etc.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The term “firmware” includes, but is not limited to, program code and data used to control and manage the interactions between the various modules of the system.

The term “hardware” includes, but is not limited to, the components of a drone and the physical housing for a computer as well as the display screen, connectors, wiring, circuit boards having processor and memory units, power supply, and other electrical or electronic components.

### ML—Machine Learning

The term “module” can refer to any component in this invention and to any or all of the features of the invention without limitation. A module may be a software, firmware or hardware module, and may be located in a user computing or communications device or a drone.

The term “processor” or “processing circuitry” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. If the processor is comprised of multiple processors, they may be located together or geographically separate from each other. The term includes virtual processors and machine instances as in cloud computing or local virtualization, which are ultimately grounded in physical processors.

The term “software” includes, but is not limited to, program code that performs the computations necessary for calculating flight paths, determining waypoints, controlling a drone, photographing structures, transmitting data, displaying information, and managing input of commands and output of data.

### B. Exemplary Embodiments

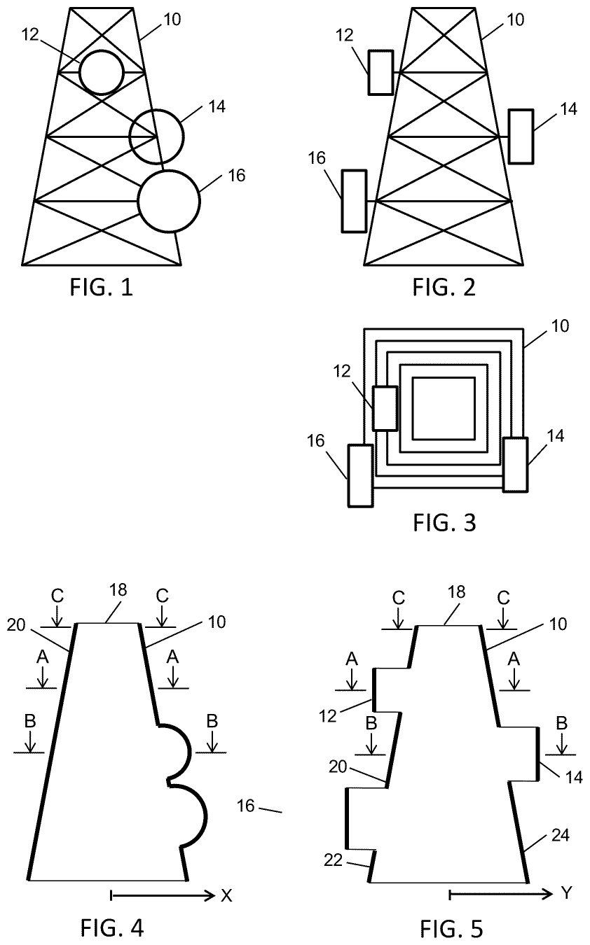

A suitable starting point is to take two preliminary photographs of the cell tower, or other structure, that is to be inspected. Referring to FIG. 1, a representation of a preliminary photograph of a cell tower 10 is shown. It has a top antenna 12 mounted on the near side, near the top of the tower. It has a middle antenna 14 on the far side, mid-way up, and a bottom antenna 16 on the near side.

The first preliminary photograph is taken with a sufficient resolution to distinguish the defining structural features of the tower, taking into account the range from which the first preliminary photograph is taken. The range is predetermined or calculated, e.g. using GPS or other known location-determining techniques, and may be 30 m (100 ft), for example. While it is possible to position the drone with an accuracy of a few centimeters, e.g. using real-time kinetic positioning and GPS, a difference of even 3 m in the two ranges is acceptable. Such defining structural features of the tower include all the features that allow the lateral extent of the tower to be determined at all the different heights up the tower, and include the antennae and the struts of the tower, for example. The pose of the camera may be horizontal, or may tilt slightly downwards or upwards towards the center of the tower. The height at which the preliminary photographs are taken is the same, to within an acceptable tolerance such as 10%. If the drone has access to the coordinates of the base of the vertical axis of the tower, then the collection of the preliminary photographs may be completed autonomously.

Next, a second preliminary photograph of the same tower is needed, but is taken at right angles from the direction that the first preliminary photograph was taken from. All other requirements of the second preliminary photograph are the same as for the first one. Referring to FIG. 2, a representation of the second preliminary photograph is shown, taken from the direction to the right of FIG. 1. It shows the tower 10, the top antenna 12, the middle antenna 14 and the bottom antenna 16. The angle does not need to be precisely 90°, and any deviation can be either corrected for or taken into account later in the process. For example, the angle between the directions of the two preliminary photographs may be in the range of 85-95°. Although inefficient, angles of even 45° or 135° would be usable. An isometric representation of a 3D structure is fully described by two images (drawings) at right angles to each other. More than two photographs can also be employed, for redundancy.

While not essential, the same camera is used for each of the two preliminary photographs, at least in part because the pixel size is a function of the resolution and focal point of the lens. It would be possible to use two different lenses, but this would then require algorithms to create equivalence between the pixel sizes. Essentially, once an area on the tower (i.e. target) is associated with a pixel, then this allows dimensions of the tower to be determined with precision. To determine the area covered by a pixel on the tower, the focal length of the camera and the range to the tower are needed. These are functions of the lens and the number of pixels in the camera. While possible, translating between different lenses, ranges or cameras is problematic for precision and image recognition.

FIG. 3 is a schematic representation of the top view of the elevation shown in FIG. 2. The antennae 12, 14, 16 are visible in their different positions on the tower 10.

The two preliminary photographs, which are ideally orthogonal, are then used to determine a 3D envelope which contains the tower. In other cases, three or more preliminary photographs each taken from different angles may be used to determine the envelope that contains the tower. For example, three preliminary photographs may be taken from directions with approximately 60° between them. Each of the preliminary photographs may also be used to determine the height of the tower, given that the range, or distance of the tower from the camera lens, is known. Other dimensions of the tower may also be determined from the preliminary photographs. With the range value and the number of pixels in each coordinate direction, combined with the resolution of the camera, the dimensions of the objects corresponding to each pixel can be known approximately, while those pixels that are coincident with the vertical axis of the tower allow the dimensions of those objects to be exactly known, subject to any inherent tolerance.

The next step is to apply an edge-detection algorithm to the preliminary photographs in order to determine the lateral extent of the tower from top to bottom. Edge detection algorithms that may be used include the Sobel filter and the Canny filter, and it is possible that other algorithms may be used. Modern image processing is able to discern edges, even with complex backgrounds. In the worst case, obtaining a suitable edge detection image may involve an interactive image process with a user in order to ensure that a suitable outline has been derived. Instead of edge detection, it is also feasible to apply ML and associate a bounding box with recognizable tower structures. Assuming the bounding box tightly conforms to the size and shape of the tower and components, the dimensions of the bounding box can be utilized in much the same manner as the edges which are detected. This capability is an alternative approach to the edge detection described. It is more effective in complex environments where there are other objects that could result in errant edges, as compared to the desired edges associated with a tower. In both the case of edge detection as well as ML, the objective is the same. The output is an outline of the tower to be inspected, either in the form of edges, or else in the form of bounding boxes which describe the structure of interest in a geometrical sense.

FIG. 4 shows the lateral extents of the tower 10. It shows the left edges 18 and right edges 20 that are detected from the preliminary photograph of FIG. 1. Only the outermost edges as viewed from the sides are needed, i.e. the edges that together span the full height of the tower, or the full height of the portion of the tower to be inspected. As such, the edges that are detected within the outermost edges may be disregarded or deleted from these images. FIG. 4 may be referred to an edge-detected image. FIG. 5 shows the left edges 22 and right edges 24 of the tower 10 that are detected from the preliminary photograph of FIG. 2. In this image, the left and right edges are broken into discrete elements.

Once the outermost edges have been detected, the maximum extent of the tower in any horizontal plane or slice can be calculated. If the two preliminary photographs have been taken from orthogonal directions, then the shape of the maximum extent in any plane is in general a rectangle, or a square when the extents are the same. If the preliminary photographs are not orthogonal, the maximum extents are defined by a parallelogram, which in some cases may be approximated to a rectangle.

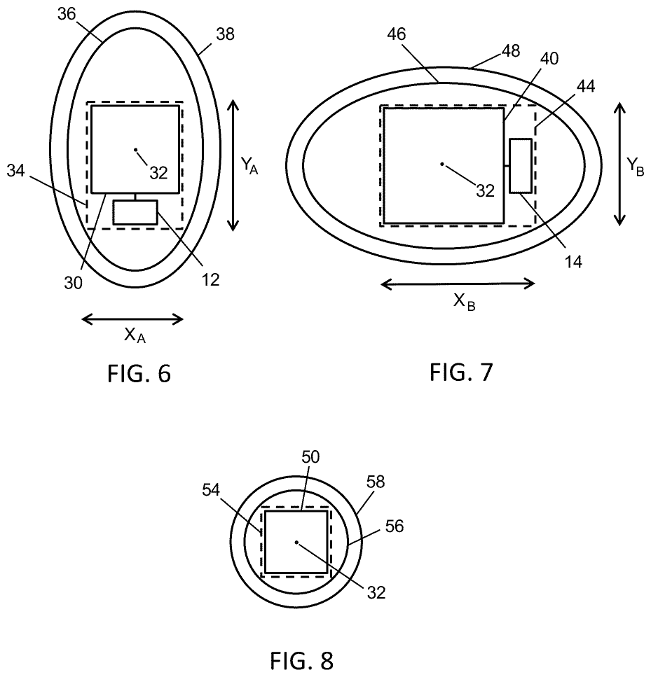

FIG. 6 shows a horizontal section through the tower at height A, showing the portion 30 of the frame of the tower at that height and the antenna 12 at that height. The central axis 32 (or “axis”) of the frame of the tower is shown. The central axis 32 is a geometrical construct and therefore may be void of any structure of the tower. Around this horizontal section of the tower a dashed line shows the rectangular envelope 34 that encloses the section. The dimensions of the rectangular envelope are XA and YA. It can be seen that the center of the rectangular envelope 34 is offset from the axis 32 of the tower due to the presence of the antenna 12 at that level. In practice, the sides of the rectangular envelope 34 coincide with the portion 30 of the frame and the antenna 12, and a small gap is only shown here for clarity. Knowing the dimensions and position of the rectangular envelope 34 or at least its corner farthest from the axis, an enveloping ellipse 36 that is centered on the axis 32 of the tower is generated such that the enveloping ellipse 36 just encloses the rectangular envelope 34, and therefore just encloses the structure of the tower at that height.

Once the enveloping ellipse 36 is defined, an enlarged ellipse 38 is defined that is also centered on the axis 32 of the tower. This enlarged ellipse 38 defines the potential flight path of the drone around the tower at this particular height. The larger the stand-off of the enlarged ellipse 38 from enveloping ellipse 36, the greater the errors that can be tolerated for the rectangular envelope 34. For example, errors of 0.5 m may be allowed for by standing-off the enlarged ellipse 38 from the enveloping ellipse 36 by 3 m, or even 10 m, for example.

FIG. 7 shows a horizontal section through the tower at height B, showing the portion 40 of the frame of the tower at that height and the antenna 14 at that height. The central axis 32 of the frame of the tower is shown. Around this horizontal section of the tower a dashed line shows the rectangular envelope 44 that encloses the section. The dimensions of the rectangular envelope are XB and YB. It can be seen that the center of the rectangular envelope 44 is offset from the axis 32 of the tower due to the presence of the antenna 14 at that level. Knowing the dimensions and position of the rectangular envelope 44 or at least its corner farthest from the axis, an enveloping ellipse 46 that is centered on the axis 32 of the tower is generated such that the enveloping ellipse 46 just encloses the rectangular envelope 44, and therefore just encloses the structure of the tower at that height. Once the enveloping ellipse 46 is defined, an enlarged ellipse 48 is defined that is also centered on the axis 32 of the tower. This enlarged ellipse 48 defines the potential flight path of the drone around the tower at this particular height.

FIG. 8 shows a horizontal section through the tower at height C, showing the portion 50 of frame of the tower at that height, where there is no antenna. The central axis 32 of the frame of the tower is shown. Around this horizontal section of the tower a dashed line shows the square envelope 54 that encloses the section. The square envelope 54 is centered on the axis 32 of the tower. An enveloping circle 56 is generated such that it just encloses the square envelope 54. Once the enveloping circle 56 is defined, an enlarged circle 58 is defined that is also centered on the axis 32 of the tower. This enlarged circle 58 defines the potential flight path of the drone around the tower at this particular height.

One way of calculating the enlarged ellipses from the enveloping ellipses is to normalize all measurements, take the mathematical determinant, expand by a given percentage and then reverse the normalization. In other words, consider an ellipse that is contained in the plane of 2 dimensions. The general equation for an ellipse is (x−c)\hat{ }T A(x−c). In the case of 2 dimensions, (x) is a 2-dimension column vector that represents the planar orthogonal axes, (c) is a two-dimensional column vector representing the center of the ellipse, (A) is a 2×2 matrix. An ellipse degenerates into a circle in the case of (A) having equal diagonal elements and zeroes for the off-diagonal elements. An object of this invention is to determine the values of (c) and (A) for each horizontal plane of the object of interest such that the set of 2 dimensional ellipses circumnavigates the object of interest in an optimal sense. The determinant of the equation for an ellipse can be utilized to normalize the equation. The normalized equation can then be scaled by using multiplicative factors.

By finding equally spaced points on the circumscribed ellipses for the object of interest, the waypoints are determined. The size of the ellipses and hence the spacing of the waypoints are accomplished by suitably choosing the factor by which the ellipses are enlarged.

It is also possible to make the calculations without normalization, however, these calculations would be more involved in order to obtain a uniform standoff. A fixed standoff, while possible, is not desired because the size distribution of the ellipses and circles is not uniform.

If the standoff is larger than the size of an indentation, then the risk of the drone becoming snagged within that indentation is relatively low. To prevent snagging of the drone, the height of the drone is taken into account, as well as the dimensions of the enlarged ellipses neighboring the indentation.

The outermost edges detected in FIGS. 4 and 5 are in practice pixelated, according to the resolution of the camera used to take the preliminary photographs, and the resolution of the edge-detecting algorithm. For example, the height of the edge-detected images may be 600 pixels. Both an enveloping ellipse and an enlarged ellipse are calculated for each level of pixels in the edge-detected images.

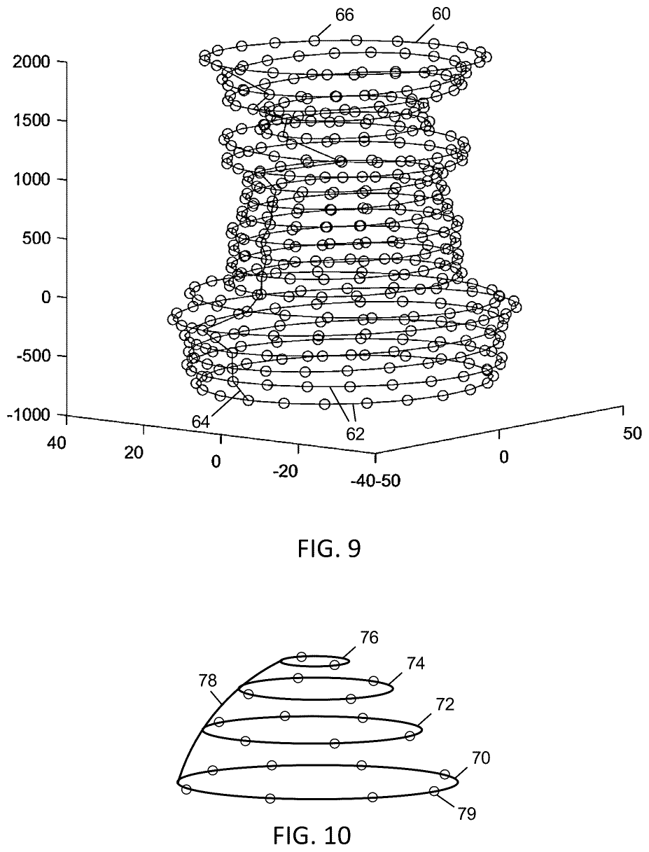

A flight path 60 with multiple flight ellipses 62, spanning a portion of the height of a different tower is shown in FIG. 9. The flight ellipses 62 are joined with sections 64, and it can be seen that the flight ellipses approximately conform to the profile of the tower. Waypoints 66 are defined on the flight path. At the waypoints 66, the camera on the drone takes one or more inspection photographs of the tower. The waypoints may be equally spaced around each ellipse, or they may be positioned with equal angular spacing. The determination of the waypoints can be imagined by calculating the circumference of the path of the ellipse and dividing it into equal segments, with a waypoint at each end of the segment. The drone may stop at each waypoint to take the inspection photograph, but it is more efficient if the drone continues to fly while taking the inspection photograph, at a speed slow enough not to cause blurring of the image.

In the flight path it is possible to use all the enlarged ellipses that have been calculated, so that the drone circumnavigates the tower at every pixel level. However, due to potentially large overlap of the images obtained when inspecting the tower, some of the enlarged ellipses may be omitted when generating the flight path. For example, every adjacent pair of enlarged ellipses may be replaced with the larger enlarged ellipse of the pair so that the flight path circumnavigates the tower half the number of times. That is, each flight ellipse of the flight path then corresponds to two pixels in height of the detected outermost edges in the edge-detected images. In other cases, pixels and their corresponding enlarged ellipses may be grouped into 3, 4, 5 or more, for example 12 or 24, so that there is more space between the levels of the flight path. The resulting flight ellipses may be referred to as a body set of flight ellipses as they surround the body of the tower.

As in FIG. 10, the top of the drone path may be augmented or completed by a dome of decreasing flight ellipses or flight circles 70, 72, 74, 76, adjacent ones of which are joined by connecting flight path segments 78. These may be referred to as a dome set of flight ellipses or flight circles. The size, shape and orientation of the bottom flight ellipse in the dome may be, for example, the same as the flight ellipse in the top of the flight path 60. The remainder of the flight ellipses 72, 74, 76 in the dome may then be proportional to the bottom one 70. In some embodiments, the dome excludes flight ellipse 70. Waypoints 79 are defined in the flight ellipses of the dome.

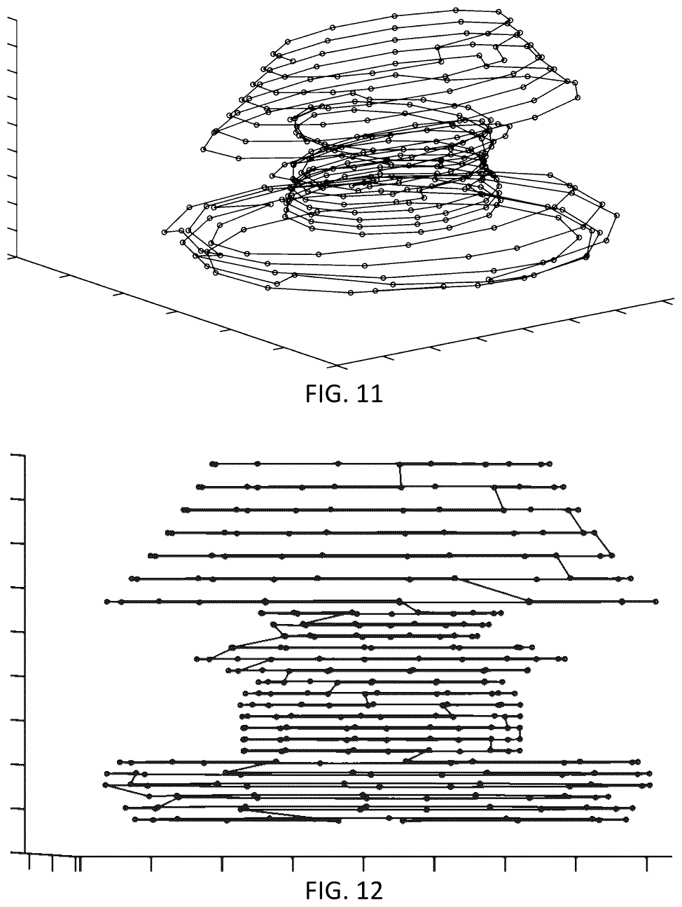

FIG. 11 is a flight path that combines the body and top portions of the path, and includes waypoints. The graduations in the horizontal plane are labeled in GPS coordinates, for example, and the vertical graduations may be in meters above ground level, for example. FIG. 12 is a side view of the same flight path.

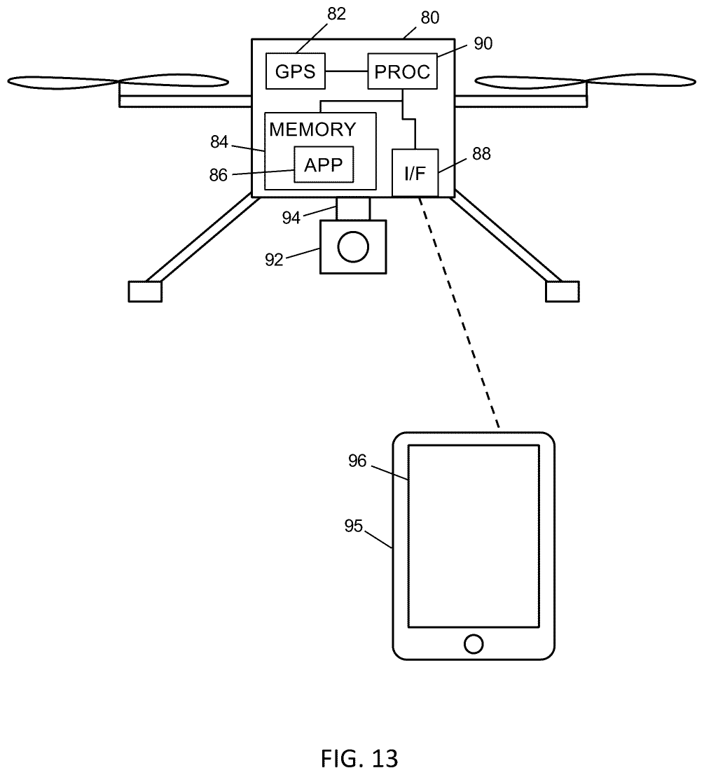

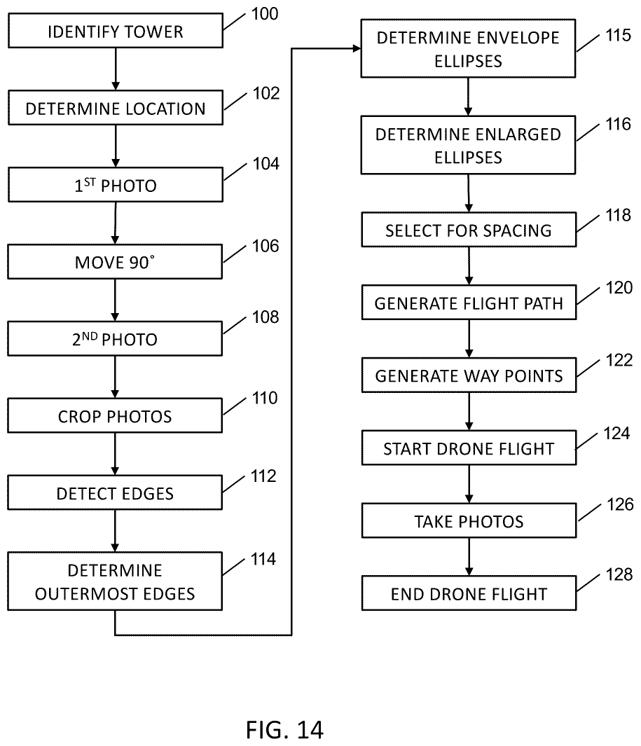

FIG. 13 shows exemplary components of a drone 80 that may be used for taking preliminary and/or inspection photographs of the tower. The drone 80 includes a GPS unit 82, a computer-readable memory 84 storing computer-readable instructions in the form of an application 86 and a wireless communications interface 88, all connected to a processor 90. A camera 92 is carried by a gimbal 94 on the drone 80 and is also connected to the processor. The processor 90 executes the instructions in the application in order to control the position and flight of the drone, and the taking of photographs. A remote-control device such as a tablet 95 is communicatively connected to the interface 88 of the drone 80. The tablet 95 is used to control some of the operation (e.g. start, stop) of the drone and/or the camera via a touchscreen interface 96, for example. The tablet 95 and/or the processor 90 execute computer-readable instructions in order to generate the flight path of the drone and the waypoints at which inspection photographs are to be taken. For example, in one embodiment, the edge detection may be calculated onboard the drone whereas the calculation of the flight path may be calculated on the tablet. In other embodiments, the division of the various functions necessary for flying the drone and taking the inspection photographs is different. These operations can also be completely contained on the onboard flight processor which would make the tablet, or other ground processor redundant.

### C. Exemplary Method

An exemplary method for photographing a tower or other similar structure is shown in FIG. 14. In step 100, a tower is identified. This may be done manually or automatically. If done automatically, a drone, which is trained by the known process of machine learning to recognize towers and in general tower-like structures, is flown in an area where it is believed that there is a tower. The drone flies around, monitoring images taken by its onboard camera, and as a result of the analysis of these images, the drone identifies the tower. The drone may be the same one as or different to the one used for taking inspection images of the tower.

In step 102, the location of the tower is determined, which may be done manually or automatically. This may be done by determining the centerpoint of the base of the tower. The axis of the tower passes vertically through the centerpoint of the base of the tower. One way to determine the centerpoint is to place two GPS receivers on or equidistant from opposite sides or corners of the tower, and then find the centerpoint of the line that connects these two points. One GPS receiver may be used twice, once in each position. Depending on the specification of the GPS receiver, this may result in accuracy with a tolerance of less than 1 cm. This may be a manual step and it does not require any flight capabilities. Another method for locating the centerpoint of the tower's base is to fly the drone over the top of the tower and mark the centerpoint of the tower on an image that is taken looking straight down onto the top of the tower. The coordinates of the drone when above the centerpoint then define the location of the axis of the tower. Alternatively, a multiplicity of images (photographs), at known GPS location can be collected. From these images, and known pose of the camera, the intersection of multiple normals (perpendiculars) to the photographs determine the center point of the base of the tower.

In step 104, a first preliminary photograph of the whole tower is taken by the drone from one side of the tower. In step 106, the drone is then flown around to another side of the tower, at 90° to the first side. In step 108, a second preliminary photograph of the whole tower is taken by the drone from the second side of the tower.

In step 110, the two preliminary photographs are cropped in order to remove extraneous image portions from around the tower. In step 112, the images are processed to detect the edges of the tower. This may result in black and white images of the tower's edges. In step 114, the lateral, outermost edges of the tower are determined, and any inner edges of the tower are removed or disregarded. All of these steps are conducted without human intervention.

In step 115, the envelope ellipses are calculated at each pixel level of the edge-detected images. Again, this step is automated.

In step 116, the enlarged ellipses at each pixel level of the edge-detected images are calculated. The calculations are performed in the coordinate system of the pixels for the images. The enlarged ellipses to be used in the flight path are then optionally reduced in number by selecting every nth one and disregarding the others, in step 118. This may involve adjusting the size of one or more of the selected ones to be the largest of each group of n larger ellipses, or the largest of a group that spans the height of the drone. The value of n may be 1, 2, 3, 4-12, 13-24 or more, for example, depending on the resolution of the pixels in the edge-detected images and the desired physical spacing between the flight ellipses (i.e. orbits) of the flight path. The number of enlarged ellipses to be skipped should be low enough that inspection photographs taken on adjacent flight ellipses have some vertical overlap.

In step 120, the flight path is generated from the flight ellipses. This involves, for example, determining the GPS coordinates of the flight path based on the calculated flight ellipses and their positions relative to the axis of the tower, for which the GPS coordinates have been determined. Connecting segments of flight path are added to join the flight ellipses.

As the drone may circumnavigate the structure twice at each level, each flight ellipse and its corresponding waypoints may be duplicated and located with a miniscule vertical spacing (e.g. 1 cm) from the corresponding original flight ellipse and waypoints. This is so that the flight path is everywhere unique for the purposes of programmatic drone control, without introducing material differences in the inspection photographs taken at nominally the same waypoint. This spacing may be described as a tolerable programmatic difference. Alternately, the double circumnavigation may be accomplished without duplicating the ellipses by recording whether the drone is on its first or second pass.

In step 122, the waypoints on the flight path are determined. They are determined so that there is some horizontal overlap of the inspection photographs taken at adjacent waypoints. If the flight ellipses are duplicated, the waypoints on each resulting pair of flight ellipses have the same (X, Y) values. Again, this step is completely automated.

In step 124, the flight of the drone is started, which may be initiated by a command input to the tablet 95. While in flight, the drone takes inspection photographs of the tower at each waypoint in step 126. Each inspection photograph, as well as an audit trail of frame synchronous metadata (FSM), is transmitted to the tablet for storage in its memory. Alternately, the inspection photographs are stored in the drone for later transfer to the tablet or other computer.

The camera may optionally be set with a slight downward or upward tilt for taking the inspection photographs, rather than being directed horizontally. By tilting the camera down or up respectively, this allows the camera to capture a view towards the center of the tower. The angle of the tilt may be 15°, for example, or it may be matched to the angle by which the side of the tower being photographed is off-vertical. For example, if the side of the tower has an angle of 10° from vertical, the camera is tilted 10° down. In other cases, the camera may be aligned horizontally in one pass and tilted down 30° in the second pass around the body set of flight ellipses and tilted down 45° in only a single pass of the dome set of flight ellipses.

While tilting the camera up is also possible, practical experience shows that this alone is not as beneficial. However, it is possible to do one pass of the entire flight path with the camera tilting down and then another pass of the flight path with the camera tilted up. For example, the angles by which the camera is tilted may have the same magnitude. By tilting the camera up, the bottom surfaces of the platforms on the tower may be photographed. In step 128, the flight of the drone comes to an end.

### D. Variations

While the ellipses have been calculated to be centered on the axis, they may instead each be centered on the corresponding rectangular envelope. However, if the process uses different centers, then the results are more irregular, and require more processing, which in turn makes the process less efficient. In other embodiments, the ellipses may all become circles, i.e. the smallest circles that enclose the rectangular envelopes while being centered on the axis of the tower. However, depending on the particular section of the tower, the pixel dimensions on the target may be more uniform for an ellipse than for a circle. While not essential, uniform pixel dimensions on the targets are generally desired for photogrammetry.

It has been noted that some structures are not precisely vertical—i.e. perpendicular to the plane of the earth. In this case, the center of the tower can be imaged to follow a slanted line, versus a vertical one (that is perpendicular to the earth). To account for a slanted tower, the center point of the base of the tower can be determined with two or more preliminary still images taken at known GPS locations. Utilizing image pixels, coordinated geometric calculations and conversion to GPS coordinates results in a bottom GPS center coordinate. Additionally, the drone can be made to fly over the top of the tower and point the camera directly down (toward the earth) at a point that is perpendicular to the calculated location of the center of the base of the tower (the bottom GPS center coordinate). If the center of the top of the tower is exactly centered on the downward looking image, then the tower is, indeed, perpendicular to the earth. If the center of the tower is offset from the center of the downward looking image, then an imaginary line can be determined between the center point at the base of the tower and the resultant center point at the top of the tower. Again, this top centerpoint can be determined by making use of the offset in pixels in the top view image, and the then determining the top GPS center point. A slanted line that connects the bottom GPS location to the top GPS location is then determined. As the drone is circumnavigating the cell tower (or other object of interest), the camera is then directed toward a suitable point on the line that connects the top GPS centerpoint and the bottom GPS centerpoint. Hence, in the case of a slanted tower, the camera that is collecting photogrammetric images will always be pointed at the center of the tower, for any horizontal level of interest.

In some cases, for example towers that have minimal variation in radial extent over their height, it is possible to use circles all of the same diameter. Although this makes for simpler calculations for spacing the inspection photographs, this approach is less accurate in the general case, in which the radial dimensions of the tower and its fittings vary both angularly and vertically. The aim is to make the pixel size on the target surface of the tower as uniform as possible, so ellipses are more accurate than circles for minimizing variation in range when circumnavigating a non-circular cross-section of the tower.

In some embodiments it is possible to take two inspection photographs at each waypoint by moving the gimbal on which the camera is mounted. This is not considered to be as efficient, however, as moving the gimbal as little as possible provides for a smoother and possibly faster operation. In other embodiments, two cameras may be used, each with a different tilt with respect to the horizon, or one may be aimed level.

The flight path may be partitioned into two or more segments for flight paths that are so long as to require recharging or exchange of the drone batteries.

In some embodiments, the camera points forward or aft of the direction perpendicular to drone's line of flight.

The invention may be applied to power distribution pylons provided that allowance in the flight path is made to avoid the power cables. Other types of towers may also be photographed with the invention. In a more general case, one or more ellipsoids that enclose some or all of a tower may be determined, and the flight path selected on one or more paths on the ellipsoidal surfaces.

The invention may also be applied to cantilevered structures that project sideways from a support.

Two drones may be used to inspect the tower or other structure. The first drone may be used to take the preliminary photographs and the second drone may be used to take the inspection photographs.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. Accordingly, the specification is to be regarded in an illustrative, rather than a restrictive, sense. In general, unless otherwise indicated, singular elements may be in the plural and vice versa with no loss of generality.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

It will be clear to one having skill in the art that further variations to the specific details disclosed herein can be made, resulting in other embodiments that are within the scope of the invention disclosed. Two or more steps in the flowcharts may be performed in a different order, other steps may be added, or one or more may be removed without altering the main function of the invention. Modules may be divided into constituent modules or combined into larger modules. All numbers, parameters, dimensions and configurations described herein are examples only and actual values of such depend on the specific embodiment. Numerical values, including those specified as equal, inherently include an expected tolerance, e.g. 10% or one significant digit, unless specified as exact. Accordingly, the scope of the invention is to be construed in accordance with the substance defined by the appended claims.

While the invention herein disclosed has been described by means of specific embodiments and applications thereof, numerous modifications and variations could be made thereto by those skilled in the art without departing from the scope of the invention set forth in the claims.

1. A method for inspecting a tower with an axis, the method comprising:
taking two preliminary photographs of the tower, each from a different side of the tower, with an angle between the preliminary photographs in a range from 45° to 135°;
detecting, by one or more processors, outermost lateral edges of the tower in each preliminary photograph;
from the outermost lateral edges calculating, by the one or more processors, an enveloping ellipse at each of multiple different heights of the tower, each enveloping ellipse centered on the axis and dimensioned to just enclose the tower at the corresponding height;
calculating, by the one or more processors, an enlarged ellipse for each of the enveloping ellipses;
generating, by the one or more processors, a flight path that incorporates at least some of the enlarged ellipses; and
taking, using a drone carrying a camera, inspection photographs of the tower while flying the drone on the flight path.

2. The method of claim 1, wherein the angle ranges from 85° to 95°.

3. The method of claim 1, wherein the two preliminary photographs are taken from equal ranges from the tower and at equal heights relative to the tower.

4. The method of claim 1, further comprising:
determining location coordinates of the axis; and
expressing the flight path relative to the location coordinates.

5. The method of claim 1, further comprising incorporating into the flight path a dome of ellipses of decreasing size above the tower.

6. The method of claim 1, further comprising maintaining motion of the drone along the flight path while taking the inspection photographs.

7. The method of claim 1, further comprising calculating, from the outermost lateral edges, an enveloping circle at at least one other height of the tower, each enveloping circle centered on the axis and dimensioned to just enclose the tower at the corresponding other height.

8. The method of claim 7, wherein the enveloping ellipses and the enveloping circle or circles span a full height of the tower.

9. The method of claim 1, wherein each enlarged ellipse is >3 m larger in each radial direction than the corresponding enveloping ellipse.

10. The method of claim 1, further comprising:
selecting at least some of the enlarged ellipses to be flight ellipses, wherein the enlarged ellipses in the flight path are the flight ellipses; and
defining waypoints on the flight ellipses, wherein each inspection photograph is taken at one of the waypoints.

11. The method of claim 10, wherein each n^{th} one of the enlarged ellipses is selected to be one of the flight ellipses, where n is 2-24.

12. The method of claim 10, comprising taking a second inspection photograph:
at each waypoint; or
at a duplicated waypoint for each of the waypoints, each duplicated waypoint having a tolerable programmatic difference compared to the corresponding waypoint;
wherein the second inspection photographs are taken with a different camera tilt to the inspection photographs.

13. The method of claim 10, comprising flying the drone around each flight ellipse twice.

14. The method of claim 10 further comprising:
incorporating into the flight path a dome of ellipses of decreasing size above the tower;
defining further waypoints, in the dome of ellipses; and
taking further inspection photographs, at the further waypoints.

15. The method of claim 1 further comprising, before taking the two preliminary photographs:
identifying the tower by the drone or another drone, wherein the drone or the other drone is programmed by machine learning to recognize tower-like structures.

16. A drone for inspecting a tower, the drone comprising:
a camera;
one or more processors; and
computer readable memory storing computer readable instructions which, when executed by the one or more processors cause the drone to:
take two preliminary photographs of the tower, each from a different side of the tower, with an angle between the preliminary photographs of in a range from 45° to 135°;
detect outermost lateral edges of the tower in each preliminary photograph;
from the outermost lateral edges, calculate an enveloping ellipse at each of multiple different heights of the tower, each enveloping ellipse centered on an axis of the tower and dimensioned to just enclose the tower at the corresponding height;
calculate an enlarged ellipse for each of the enveloping ellipses;
generate a flight path that incorporates at least some of the enlarged ellipses; and
take inspection photographs of the tower while flying on the flight path.

17. The drone of claim 16, wherein the angle ranges from 85° to 95°.

18. The drone of claim 16, wherein each enlarged ellipse is >3 m larger in each radial direction than the corresponding enveloping ellipse.

19. The drone of claim 16, wherein only each n^{th} one of the enlarged ellipses is incorporated in the flight path, where n is 2-24.
